(19) United States
(12) Patent Application Publication
(10) Pub. No.: US 2022/0292239 A1
(43) Pub. Date: Sep. 15, 2022

(54) SMART TIME SERIES AND MACHINE LEARNING END-TO-END (E2E) MODEL DEVELOPMENT ENHANCEMENT AND ANALYTIC SOFTWARE

(71) Applicant: KuantSol Inc., Palo Alto, CA (US)

(72) Inventors: Aykut KAHRAMAN, New York, NY (US); Aytekin OLDAC, Lancaster, PA (US); Omer OZEREN, New York, NY (US); Alex SHAHIDI, San Jose, CA (US); Alberto Marin, Lancaster, PA (US)

(73) Assignee: KuantSol Inc., Palo Alto, CA (US)

(21) Appl. No.: 17/694,830

(22) Filed: Mar. 15, 2022

Related U.S. Application Data
(60) Provisional application No. 63/161,365, filed on Mar. 15, 2021.
(60) Provisional application No. 63/161,351, filed on Mar. 15, 2021.

(51) Int. Cl. G06F 30/27

(52) U.S. Cl. CPC G06F 30/27

(57) ABSTRACT

A process implemented as software for building, developing, and enhancing a model for use in forecasting, having a first user input step, wherein a user to input data using a user interface on a user device and providing the user input data to an application program interface (API); the API performs an auto data validation step, a feature creation step comprising using domain knowledge to extract features from raw training data; a feature encoding step comprising using the created features and raw training data to train different candidate models; a model selection step wherein the user is prompted to select a best model from the number of trained candidate models based on user defined model rankings; a best model review step comprising producing detailed information on the best model through statistical diagnostics, sensitivity, back-test and performance analysis; and generating implementation code for the best model; processing a set of data to be analyzed using the best model, forecasting an outcome based on processing the set of data to be analyzed with the best model, and providing the forecast to a user by a user interface on a user device.

### TECHNICAL FIELD

The present invention relates to the technical field of business model development and enhancement software to build and develop robust time series and machine learning models that can be used by technical and non-technical users.

### BACKGROUND OF THE INVENTION

There is an increasing need for better predictability in an increasingly complex macro environment and tightening regulatory regimes, as well as an acceleration of the consumer and business expectations for on-demand products and services coupled with financial technology (Fintech) and big box players ready to engage. Rising and emerging global macro-economic risk environments drive dynamic risk re-evaluation in response to factors such as: expanding cyber and infrastructure threats; changing and morphing socio and psychodynamics post-COVID era; long-term shifts of U.S. bilateral relationships impacting currency, capital markets and regionalization of supply chains; and polarized U.S. political landscape and corresponding uncertainty with continuity of economic and trade policies, and global events like the COVID pandemic.

In view of these growing concerns, there is a need to develop strategic solutions to enable better, faster and cheaper predictive risk modeling and analysis. Existing platforms provide data upload, data exploration and auto-model fitting without any consideration to assumption testing, enhanced exploration of decision making required in model development, strategizing model selection for purpose, or detailed output analysis. Furthermore, existing software and platforms lack the technical and functional features to intake and process all the necessary input from users according to their strategy, domain knowledge, intuition, and preferences.

Time series models or modeling techniques such as ARIMA, SARIMA, VAR, ECM, LOS and VECM have been used in the field of statistical model development that perform forecasting based on time series data with specific customization functionality required for business purposes, regulatory compliance, and model governance. A time series is a sequence of observations that are ordered in time (e.g., observations made at evenly spaced time intervals). Some examples of time series data may include minutely, hourly, daily, or monthly stock prices, monthly loss rates, delinquency rates for a portfolio, or a monthly sales amount. Future values of single time series or multiple time series can be forecasted by various modeling techniques based on series' trend and/or other exogenous series. One example of this can include forecasting credit card delinquency and loss rate based on economic indicators such as Unemployment Rate and Gross Domestic Income. But, there are countless applications of time series models across industries such as forecasting portfolio delinquency and loss rate based on economic indicators such as Unemployment Rate and Gross Domestic Product for a bank, forecasting interest rate, new money volume, portfolio credit loss and income for a financial company, forecasting stock prices for a Hedge Fund Company, forecasting monthly sales and expense for a retail company, forecasting Monthly/Daily Economic activity for an investment company, forecasting birth and death rate for a government entity, etc.

End to End time series development cycle includes various steps that requires strong statistical knowledge and coding skills. Furthermore, developers often need the right business acumen in order to make the right decisions in development. Development requires extensive amount of code to be written with the robust statistical knowledge to tackle not just running the underlying modeling algorithm, but applying the right methodology to verify data, select best features to inform target, evaluate models, select the best model, and do the right output analysis in terms of sensitivity, back-test, and model behavior.

Time series model development algorithms are complex and compounded with the regulatory and business expectations, and the development process can take 4-12 months from start to finish. Codes and analyses are re-created and tested separately for each project. It becomes a challenge for most companies to keep up with the changing environment and the associated need for re-calibration or redevelopment to capture new trends, vectors and assumptions, as well as complying with model risk governance. Robust Model development process requires adequate decision-making steps, extensive exploration and testing that are crucial to the quality and precision of the end product. Explorations and testing are usually overlooked by modelers due to time constraints and additional coding required and result in more lost opportunity.

Alternatively, to time series models, machine learning models such as Gradient Boosting, Stochastic Boosting, AdaBoost, XGBoost, LightBoost, KNN, K-Means, PCA, Logistic Regression, Decision Tree, Random Forest, Quadratic Linear Discrimination, Neural Networks, and Deep Learning, have been used in the field of predictive modeling that are developed using specific customization functionality required for alignment with business purpose, regulatory compliance, and model governance.

ML has a wide range of statistical algorithms that come in three types: (1) Supervised Learning where there is a well-defined target that can be predicted by independent features available in the data; (2) Unsupervised Learning where there is no target to predict; and (3) Reinforcement Learning where the model continuously learns from past mistakes to improve decision making. Supervised Learning algorithms are the most common algorithms used in the industry where a target can be binary (two values), numeric, ordinal, nominal or integer and algorithms predict the target based on available independent features (variables) in the data. Features indicate input variables used to develop a model. In other words, model inputs that predict the target. Models take features and predict the target based on the feature's values.

Unsupervised Learning is less common and used to do clustering and segmentation to understand relationships in unlabeled data. Reinforcement Learning has been relatively new and is finding new application and utility areas across many industries and verticals.

Machine Learning includes traditional modeling techniques such as Logistic Regression, Linear Regression and Decision Trees that have closed functional form and are transparent and explainable. An increasing number of Machine Learning applications, however, use machine learning algorithms that do not have a closed functional form such as Boosting models (XGBoost, LightBoost, CatBoost, AdaBoost), Begging models such as Random Forest, Neural Networks, clustering models such as KNN and Reinforcement Learning models such as deep learning, Q-Learning and Deep Q Learning. Machine Learning applications are increasing in an unprecedent pace across many different industries for many different purposes. Some common uses of machine learning applications include but are not limited to: banking, product propensity models to improve cross-sell, fraud detection models, sentiment assessment models to assess customer satisfaction in recorded conversations, early warning or behavior models to detect customers that are likely to default for account management purposes, marketing models to assess customers' likelihood to look for a specific credit product, and collection models that predict customers' likelihood to charge-off, interest rate forecasting, Investment Firms, stock price predictions, Retail Companies, propensity predictions such as predicting a customer likelihood to buy a certain product or an individual's likelihood to like a specific product, Sales & Expense predictions, Health Care, predicting a person's probability of catching a disease based on their health characteristics, predicting patient's probability of getting healthy based on patients condition and past treatments, other industries, Netflix-movie recommendations, Amazon-Product Recommendations, Self-Driving cars, Google-spam detection, Cybersecurity (e.g., malware detection modeling and Antagonistic network detection modeling), Epidemiology, and population risks.

The field of machine learning includes many strong but complex algorithms that are hard to fine tune. With this complexity comes with challenges such as: how to avoid overfitting, i.e., how to ensure the end model generalizes and performs well within an unknown data; hyperparameter optimization needed to evaluate model performance, selection of the best model, and evaluation of the model performance, which requires extensive coding and is prone to mistakes and subjective decisioning that is difficult to identify; experienced talent with adequate knowledge in coding and machine learning algorithms are rare in the industry or even harder to retain; reducing mistakes during model development and detecting, without the right model, risk governance and adequate review of the development (e.g., Model Risk is believed to be bigger and harder to detect for machine learning Models compared to traditional); machine learning algorithms require large volumes of good quality data which is usually not available, wherein it is imperative to perform effective data verification prior to modeling, the absence of which would result in junk; most machine learning algorithms do not have closed functional form and are seen as a black box, i.e., not transparent or explainable, thus understanding the model behavior and performance requires extensive coding and is time intensive; machine learning Model development requires adequate level of business collaboration and input, and is thus challenging to bridge the gap between business intuition and decision making; and although machine learning algorithms are strong in their ability to provide insights from the data, they do not work well in the absence of strong data verification, innovative feature engineering and model selection strategy that are in line with business purpose. Absence of these steps translates into lost opportunity and poor model performance in a large percentage of cases.

### DISCRIPTION OF RELATED ART

Patent with publication number U.S. Pat. No. 11,126,635 B2 is related to “Systems and methods for data processing and enterprise AI applications”. The invention is a platform as a service (PaaS) for the design, development, deployment, and operation of next generation cyberphysical software applications and business processes. The applications apply advanced data aggregation methods, data persistence methods, data analytics, and machine learning methods, embedded in a unique model driven architecture type system embodiment to recommend actions based on real-time and near real-time analysis of petabyte-scale data sets, numerous enterprise and extraprise data sources, and telemetry data from millions to billions of endpoints.

Patent with publication number U.S. Pat. No. 10,579,928 B2 is related to “Log-based predictive maintenance using multiple-instance learning”. The invention is a system and method for a data-driven approach for predictive maintenance using logs based on multiple-instance learning for predicting machine failures by mining machine event logs which, while usually not designed for predicting failures, contain rich operational information. The invention builds a model to capture patterns that can discriminate between normal and abnormal instrument performance for an interested component. The learned pattern is then used to predict the failure of the component by using the daily log data from an instrument.

Patent with publication number US 11068942 B2 is related to “Customer journey management engine”. The invention is a process, including: obtaining a first training dataset, training a first machine-learning model on the first training dataset, obtaining a set of candidate question sequences, forming virtual subject-entity records, forming a second training dataset, training a second machine-learning model, and storing the adjusted parameters of the second machine-learning model in memory.

Patent with publication number WO 2020041901 A1 is related to “Analysis and correction of supply chain design through machine learning”. The invention is dynamic supply chain planning system for analysis of historical lead time data that uses machine learning algorithms to forecast future lead times based on historical lead time data, and to divide historical lead time data into clusters based on seasonality and linearity. The machine learning results are further processed to adjust future planned lead times and to identify sources in the supply chain that contribute to large deviations between historical planned lead times and actual lead times.

As described above, the above documents fail to provide any consideration to assumption testing, enhanced exploration of decision making, strategizing model selection for purpose, or detailed output analysis, and they also lack the technical and functional features to intake and process all the necessary input from users according to their strategy, domain knowledge, intuition, and preferences.

### SUMMARY

To resolve the above problems, the present invention provides Smart Time Series Analytics Software (STSA) and Machine Learning Way (MLWay) model development processes that standardize, simplify, optimize and significantly shorten the model development and validation cycle while enabling streamlined and automated governance, compliance, model interpretability, model quality, and focus on business engagement. The primary outcome of STSA and MLWay is to seamlessly simulate the whole development process from start to finish, provide flexibility and functionality to incorporate business input where necessary, and improve the understanding of the model behavior, nuances and performance through customizable configuration and reporting features. Further, STSA and MLWay provide enhanced exploration and testing capabilities that are key to a robust predictive model development. No statistical model is perfect, and all models come with risk. Using a model without understanding the model risk can lead to wrong or sub-optimal predictions or decisions that can be unacceptable and costly in real life. Model risk can come in many forms; model bias and wrong accuracy due to data quality, high model bias and uncertainty due to improper variable and model selection and lack of exploration, lack of interpretability and explainibility of the model output. STSA and MLWay inventions improve the technology of using statistical models to provide unique capabilities and standardization of model development to understand and decrease model risk, in other words increase model quality for the business purpose not for just Banking but for any business in need to use Time Series and Machine Learning models to help with a business problem.

According to this invention provides process for building, developing, and enhancing a model for use in forecasting having a first user input step, wherein a user to input data using a user interface on a user device and providing the user input data to an application program interface (API), where the API performs an auto data validation step comprising using the user input data to apply the following to the raw training data: elimination of duplicate data, either manually or standardized, selection of missing imputation functions, identification of low frequency values in categorical variables and proposing to eliminate or keep the categorical variables, and capping values or input standardization to form outlier identification; a feature creation step comprising using domain knowledge to extract features from raw training data; a feature encoding step comprising using the created features and raw training data to train different candidate models; a model selection step wherein the user is prompted to select a best model from the number of trained candidate models based on user defined model rankings; a best model review step comprising producing detailed information on the best model through statistical diagnostics, sensitivity, back-test and performance analysis; and generating implementation code for the best model; processing a set of data to be analyzed using the best model, forecasting an outcome based on processing the set of data to be analyzed with the best model, and providing the forecast to a user by a user interface on a user device.

In a preferred embodiment, the feature creation step comprising using domain knowledge to extract features from raw training data using log, polynomial, interaction functions such as division of two inputs, multiplication of two inputs, momentum, drift, and variance functions a feature imputation step is performed after the feature creation step, the feature imputation step comprises modeling each feature as a function of each other feature, imputing each feature sequentially, and allowing each feature to be used to predict subsequent features; wherein the feature imputation process step is repeated at least once, and wherein imputing is performed using one of: KNN, performance-based, iterative imputation, mean, median, and mode; and the feature encoding step further comprising using a categorical data encoding technique when the categorical variables are ordinal, producing labels through label encoding, ordinal coding or one hot encoding, and converting the labels into numeric values via multiple statistical techniques.

In a preferred embodiment, the different candidate models are selected from at least one of the following time series models: ARIMA, SARIMA, VAR, ECM, and VECM.

In a preferred embodiment the invention further has a best model validation step producing a comprehensive report of the statistical diagnostics tests, performance evaluations, sensitivity analysis, and model ranking based on the configuration selected by the user.

In a preferred embodiment the invention further has a model comparison step comprising comparing the best model to another model in the number of candidate models with an option to determine a new best model; and a documentation materials step comprising saving the comprehensive report as a file.

In a preferred embodiment, the different candidate models are selected from at least one of the following machine learning models: Gradient Boosting, Stochastic Boosting, AdaBoost, XGBoost, LightBoost, KNN, K-Means, PCA, Logistic Regression, Decision Tree, Random Forest, Quadratic Linear Discrimination, Neural Networks, and Deep Learning.

In a preferred embodiment the invention further has a feature and target analysis step comprising providing summary statistic and visual inspection of the data that is helpful in decision making with respect to a data partition and a feature creation; a data partition and segmentation step comprising partitioning the data into training data, validation data, and out-of-sample data for use in hyperparameter tuning, model selection, and performance analysis, and providing data size statistics and industry standards for minimum size requirements, customizable clustering analysis and variable importance analysis across partitions; a feature filtering step comprising leveraging variance and information values to filter or create new features; a model design step comprising selecting, automatically or manually by user input, all applicable models of the set of models, a standalone model of the set of models based on customizable ranking criteria, or applying stacking wherein a final model is based on a collective prediction of at least one model of the set of models; a hyperparameter tuning step applied to each of the number of candidate models comprising applying at least one of the following techniques: Grid, Soft Grid, Randomized and Bayesian search; and a model ranking step comprising comparing the best model to another model in the set of models based on model stability, sensitivity, and/or customizable performance evaluation that includes error distributions, bias and uncertainty calculations, and statistical diagnostics.

In a preferred embodiment, the feature creation step further comprising defining a selection of strongest variables in terms of explanatory power against the target selection input, and applying at least one selected from the following: Recursive Feature Elimination, Model Ranked, Variance Threshold, Missing/low frequency Threshold, F Test, Ch2 Test, Lasso, Ridge, Backward, Forward and Stepwise sequential selections, Information Value, and Variable Clustering.

In a preferred embodiment, the feature creation process step further the user selects at least one of the features to extract potential inputs, and/or wherein the user eliminates variables deemed to be unintuitive based on domain knowledge.

In a preferred embodiment, the invention further has a model comparison step comprising comparing the best model to another model in the number of candidate models with an option to determine a new best model.

STSA takes out the coding and the statistical burden from the process and provides a user-friendly tool to develop robust time series models for practitioners. Software also makes the whole development cycle significantly faster and improves efficiency. It also lowers cost and complexity of more dynamic or shorter interval refinement of risk model assumptions.

MLWay is an augmented Machine Learning Model development and architecting software that can be used by technical and non-technical users. It standardizes the machine learning model development process while keeping the project specificity by providing customizable features in each step of the development to improve robust and innovative decision-making in line with the business purpose for a better end product. The software has apparatuses to perform data verification, feature engineering, model design and model technique selection, statistical diagnostics, model fitting and selection, performance evaluations, and implementation. Software outputs all statistical analysis results and related performance metrics for documentation purposes. The software is comprehensive and already incorporates most common Machine Learning Algorithms: Gradient Boosting, Stochastic Boosting, AdaBoost, XGBoost, LightBoost, KNN, K-Means, PCA, Logistic Regression, Decision Tree, Random Forest, Quadratic Linear Discrimination, Neural Networks, and Deep Learning, where more is being added with time.

Similar to STSA, MLWay takes out the coding and the statistical burden out of the equation and provides a user-friendly tool to develop robust machine learning models for practitioners and subject matter experts. It lowers cost and complexity of more dynamic or shorter-interval refinement of model assumptions due to more dynamic macroeconomic changes. It narrows the gap between complex model development process and business oversight; and helps with model governance process to identify model risk regulatory compliances that are common in several industries such as Finance, Banking, and Insurance by providing no hassle customizable approach to sensitivity analysis, model selection, hyper parameter optimization, and most importantly model performance evaluation.

The STSA and MLWay software will help organizations to achieve improvements in multiple fronts with respect to time series and machine learning model development, specifically: cutting time series and machine learning model development, calibration and implementation more than 80%; enabling easier and faster exploration and testing of choices and decisions made in all phases of time series and machine model development for robust model development and optimal model performance; and providing full transparency in time series and machine learning model development process in decision making with respect to data selection, variable creation and selection, model selection, output analysis and model explanation; improving compliance with Model Risk Governance.

STSA will further improve regulatory compliance in TS model development for comprehensive capital analysis and review/business as usual/current expected credit loss purposes. MLWay will further help users to achieve improvements in multiple fronts with respect to robust forecasting and risk strategy via Machine Learning models: being repeatable and less prone to user errors and modeling mistakes; optimizing value extraction from machine learning models; significantly reducing the need and dependency on costly talent needed to develop advanced machine learning models; narrowing the gap between complex modeling process and business oversight; helping to bridge the gap between business intuition and decision making required in machine learning model development; and offering novel approaches to tackle common problems faced in machine learning model development such as Feature Engineering, Hyperparameter Tuning, Model selection, Model Evaluation, Overfitting and understanding model behavior and risk.

### BRIEF DESCRIPTION OF THE DRAWINGS

To describe the technical solutions in the embodiments of the present invention more clearly, the following briefly describes the accompanying drawings required for describing the embodiments. It should be understood that the following accompanying drawings show merely some embodiments of the present invention, and therefore should not be regarded as a limitation on the scope. A person of ordinary skill in the art may still derive other related drawings from these accompanying drawings without creative efforts.

FIG. 1 is a flow diagram of the time series model development structured in the STSA according to an embodiment of the present invention.

FIG. 2 is a flow diagram of the machine learning model development structured in the MLWay according to an embodiment of the present invention.

### DETAILED DESCRIPTION OF THE EMBODIMENTS

The references used in the Figures are as follows:

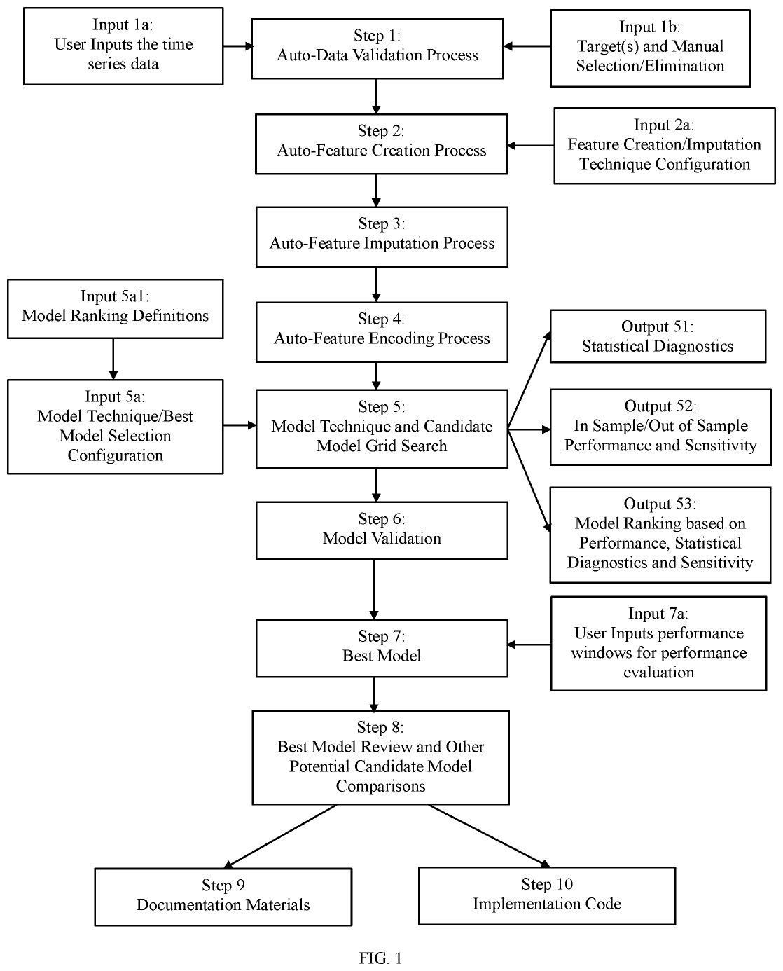

In FIG. 1, Step 1: Auto-Data Validation Process; Input 1a: User Inputs the time series data; Input 1b: Target(s) and Manual Selection/Elimination; Step 2: Auto-Feature Creation Process; Input 2a: Feature Creation/Imputation Technique Configuration; Step 3: Auto-Feature Imputation Process; Step 4: Auto-Feature Encoding Process; Step 5: Model Technique and Candidate Model Grid Search; Input 5a: Model Technique/Best Model Selection Configuration; Input 5a1: Model Ranking Definitions; Output 51: Statistical Diagnostics; Output 52: In Sample/Out of Sample Performance and Sensitivity; Output 53: Model Ranking based on Performance, Statistical Diagnostics and Sensitivity; Step 6: Model Validation; Step 7: Best Model; Input 7a: User Inputs performance windows for performance evaluation; Step 8: Best Model Review and Other Potential Candidate Model Comparisons; Step 9: Documentation Materials; Step 10: Implementation Code; , 2a and 5a represent user input into the software in the form of data or configuration settings.

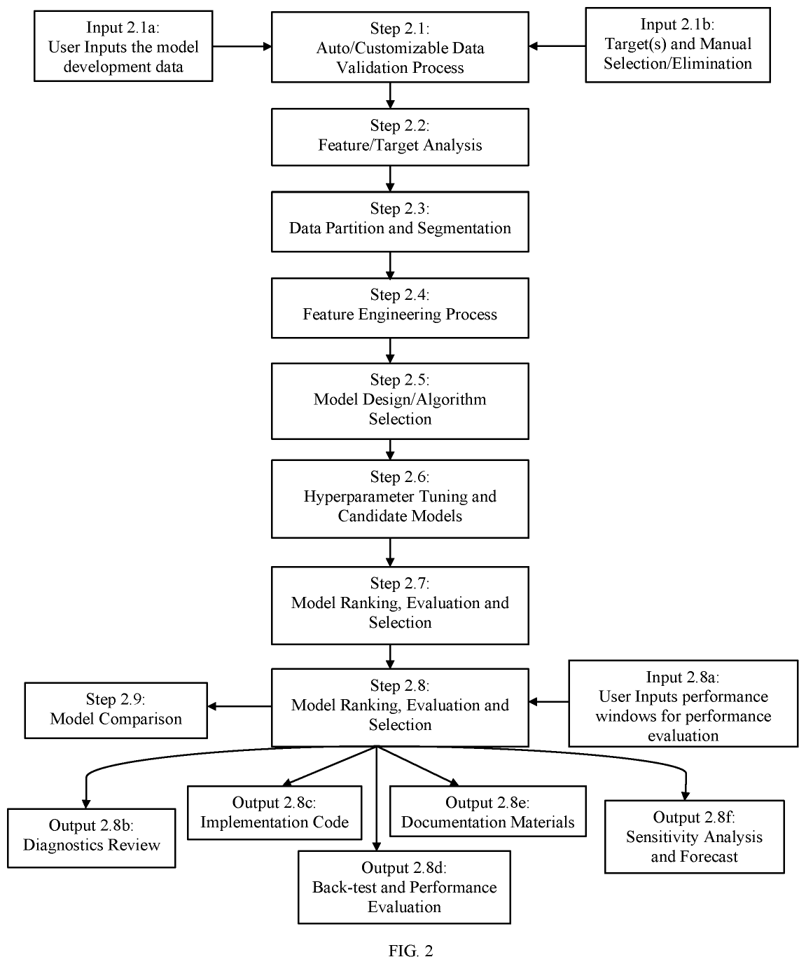

In FIG. 2, Step 2.1: Auto/Customizable Data Validation Process; Input 2.1a: User Inputs the model development data; Input 2.1b: Target(s) and Manual Selection/Elimination; Step 2.2: Feature/Target Analysis; Step 2.3: Data Partition and Segmentation; Step 2.4: Feature Engineering Process; Step 2.5: Model Design/Algorithm Selection; Step 2.6: Hyperparameter Tuning and Candidate Models; Step 2.7: Model Ranking, Evaluation and Selection; Step 2.8: Best Model; Input 2.8a: User Inputs performance windows for performance evaluation; Output 2.8b: Diagnostics Review; Output 2.8c: Implementation Code; Output 2.8d: Back-test and Performance Evaluation; Output 2.8e: Documentation Materials; Output 2.8f: Sensitivity Analysis and Forecast; Step 2.9: Model Comparison.

The present invention is in the field of machine learning and the terms used throughout the disclosure have their ordinary meaning to those skilled in the art of machine learning. Certain terms used through the disclosure have the following meanings:

The term “feature” indicates input variables used to develop a model. In other words, a feature is an individual measurable property characteristic, or attribute in a data set produced from a measurable or observable phenomenon. The data set is analyzed using domain knowledge or the machine learning model to extract features from the data set. The extracted features improve the quality of results from the machine learning process. Models take features and predict a target output based on the feature's values. For instance, in the field of economics, macro features such as unemployment rate, real GDP can be used to predict credit card portfolio delinquency or loss rate.

The term “hyperparameter” refers to parameters specific to machine learning algorithms. A hyperparameter is a parameter is a parameter whose value is used to control the learning process itself. Machine learning algorithms rely on model specific configuration inputs to search for the best model. These model specific configuration inputs are called hyperparameters. For example, a Random Forest machine learning algorithm includes the following hyperparameters: number of trees, maximum debt, minimum number of data points in a node, minimum number of data points in a leaf node, bootstrap, maximum number of features.

The term “model” in machine learning refers to a mathematical model comprising algorithms and/or data structures (e.g. vectors, arrays, matrices, trees, mathematical maps, tensor, etc.) which are trained on data such as training data or initial data. A trained model is then able to process additional data and make predictions or forecasts based on the additional data. Various types of models are readily known to those skilled in the art such as artificial neural networks, decision trees, support-vector machines, regression analysis, Bayesian networks, and genetic algorithms, etc.

The term “train” is the process by which a machine learning algorithm processes data and builds a specific model, which is called “learning”. In supervised learning, first sample data that contains both the inputs and the desired target outputs is processed by the machine learning algorithm to produce a model. Under supervised learning, the desired outputs are referred to as a supervisory signal which train the model to produce the desired outputs based on the given inputs. As discussed previously, supervised learning algorithms are the most common algorithms used in the industry where a target can be binary (two values), numeric, ordinal, nominal or integer and algorithms predict the target outputs based on available independent features (variables) in the data. Features indicate input variables used to develop a model. In unsupervised learning, the training the machine learning algorithm processes a set of data that contains only inputs. Presently, unsupervised learning is less common than supervised learning and is used to do clustering and segmentation to understand relationships in unlabeled data. Under unsupervised learning, the machine learning algorithm finds structure, or commonalities, in the data and reacts based on the presence or absence of the commonalities in each new piece of data. Semi-supervised learning falls between supervised and unsupervised learning where some training data is labeled (supervised) and some training data is unlabeled (unsupervised). Other types of machine learning such as reinforcement learning where the model continuously learns from past mistakes to improve decision making, would be readily understood by those skilled in the art.

For the sake of a better understanding of the above technical solutions, the technical solutions in the present invention are described in detail with reference to the accompanying drawings and specific embodiments. It should be understood that the embodiments of the present invention and specific features in the embodiments are detailed descriptions of the technical solutions in the present invention, and are not intended to limit the technical solutions in the present invention. The embodiments in the present invention and technical features in the embodiments may be combined with each other in a non-conflicting situation.

FIG. 1 presents a first embodiment of the invention, specifically a flowchart of a high-level flow of the time series model development structured in the STSA. Inputs 1a, 1b, 2a, 5a and 7a represent user input into the software in the form of data or configuration settings. Steps 1-10 are automated features of the software with the necessary configuration settings made by the user. Outputs 51, 52, and 53 represent output information resulting from the respective steps from which they stem.

Specifically, Step 1 represents an Auto-Data Validation Process step. Data is a necessity to any model development. No matter how powerful a candidate machine learning algorithm is, the quality of end product is dependent on the quality of the data the algorithms are being trained on. Models learn from the training data, which is the data used to develop the model. It is best practice to separate validation data sets and out-of-sample data sets to ensure the trained model performs adequately on the validation and out-of-sample data sets. In modeling, all available data usually are portioned into training, validation and out of sample.

Random noise (i.e., data points that make it difficult to see a pattern), low frequency of a certain categorical variable, low frequency of the target category, duplicates, missing values, and incorrect numeric values are few examples of common issues faced in model development data quality assessment. While the validation process cannot directly show the source of the data quality issues, it can identify the problem and offer fixes. The following are the checks applied by the STSA software to ensure data quality, thereby offering solutions to handle these issues for the user: Duplicate identification based on segment and time ID, wherein STSA offers eliminations of duplicates manually or through a standardized approach; missing values in the data, wherein STSA allows users to select one of many different missing imputation functions (mean, median, mode, KNN, performance based, etc..); identification of low frequency values in categorical variables and propose user to eliminate them or keep them; outlier identification, solved in the form of capping values or standardization of the inputs; continuity of the data, as time series models are highly sensitive to time dimension and can produce unstable results if certain time frames are missing from the data; and identification of structural changes in the target.

The Auto-Data Validation step may also receive target selection of user identified features for extraction and manual elimination of unwanted features by the user. The target selection and manual elimination of unwanted features results in dimensionality reduction thereby reducing the number of random variables under consideration.

Next, Step 2 represents an Auto-Feature Creation Process step. Feature engineering is the process of using domain knowledge to extract features, or variables, from raw data that may have strong explanatory power for the target. These features have the potential to improve the performance of time series algorithms manifold.

Automated feature engineering provides standard transformation functions to automatically extract new features which include but not limited to: log, polynomial, interaction functions such as division of two inputs, multiplication of two inputs, momentum, drift, variance functions etc. A user can select all or some of these transformations in the development process to extract potential inputs to the model development. A user can eliminate variables deemed to be unintuitive based on their domain knowledge later in the process regardless of the feature's explanatory power.

Step 3 represents an Auto-Feature Imputation process step. Feature imputation, also referred to as iterative imputation, refers to a process where each feature is modeled as a function of the other features, e.g. a regression problem where missing values are predicted. Each feature is imputed sequentially, one after the other, allowing prior imputed values to be used as part of a model in predicting subsequent features. This process is repeated multiple times, allowing ever improved estimates of missing values to be imputed. The STSA software uses various methods to impute missing that includes but not limited to KNN, Performance-Based, mean, median, and mode or most frequent.

Step 4 represents an Auto-Feature Encoding Process step. Converting categorical data is an important activity in modeling. It not only elevates the model quality but also helps in better feature engineering. Better encoding leads to a better model and most of the algorithms cannot handle the categorical variables unless they are converted into numerical values. The STSA software uses categorical data encoding technique when the categorical feature is ordinal. In this case, retaining the order is important. Hence encoding should reflect the sequence. Software uses in label encoding; each label is converted into a numeric value via multiple statistical techniques.

Step 5 represents a Model Technique and Candidate Model Grid Search step. There are various time series modeling techniques the software is able to use. Depending on the number of targets and the relationship among the targets proven by statistical tests, software selects the most suitable time series modeling technique. The user is also able to select the modeling technique manually which is subject to statistical test compliance that software provides. There is no statistical technique to select robust candidate models in literature and software applies an exhaustive research based on the configuration selected by the user. The STSA software provides the necessary statistical diagnostics tests, performance evaluations, sensitivity analysis and model ranking based on elected criteria. This is a novel approach in time series model development cycle that adds significant value to the whole process from a robust model development and model risk management perspective.

Step 6 represents Model Validation step. Model Validation produces a comprehensive report that includes all statistical diagnostics, performance evaluations, sensitivity, ranking based on user defined criteria for information purposes. The user is able to change the ranking criteria, and observe each candidate model's performance, sensitivity, inputs to make an informed decision to select the best model.

Step 7 represents a Best Model step. Once the best model is selected in Step 6, the STSA software produces all relevant detailed information on the best model; statistical diagnostics, sensitivity, back-test based on different performance windows, etc. Software provides additional functionality to do further in-depth output analysis. The user can input different performance windows in Input 7a for performance evaluation, apply customized sensitivity analysis, evaluate performance for different time frames and input scenarios in this module.

Step 8 represents Best Model Review and Other Potential Candidate Model Comparisons step. The STSA software enables the user to compare the best model to any other candidate model identified in the exhaustive search (from Step 5). It is common in modeling to compare different models to enhance the output analysis of the best model and to assign a challenger model. The user is able to assign a challenger in this step, in addition to best model.

Step 9 represents Documentation Materials. The STSA software saves all relative analysis, data, output in a dedicated folder properly structured to be used in the model documentation. Robust and complete documentation of the whole development cycle is imperative for model risk management and regulatory purposes.

Finally, Step 10 represents Implementation Code. The STSA software in this step exports the execution code to be used in implementation. The implementation is used to achieve forecasting of a particular business output. For STSA, example outputs may comprise loss forecasting based on Macro economic variables, Fee Income forecasting, and New Money origination forecasting.

FIG. 2 presents a second embodiment of the invention, specifically a flowchart of a high-level flow of the MLWay software. Steps 2.8b-f are output. Inputs 2.1a-b and 2.8a represent user input into the software in the form of data or configuration settings. Steps 2.1-2.9 are automated features of the software with the necessary configuration settings made by the user. Outputs 2.8a-e represent output information resulting from the respective steps from which they stem.

Step 2.1 represents an Auto/Customizable Data Validation Process, which is analogous to the Step 1 of the embodiment of FIG. 1. The following are the checks applied by the MLWay software, each of which are common to the STSA software discussed above, to ensure data quality, thereby offering solutions to handle these issues for the user: Duplicate identification based on segment and time ID, wherein MLWay offers eliminations of duplicates manually or through a standardized approach; missing values in the data, wherein MLWay allows users to select one of many different missing imputation functions (mean, median, mode, KNN, performance-based, etc..); identification of low frequency values in categorical variables and propose user to eliminate them or keep them; outlier identification, solved in the form of capping values or standardization of the inputs.

Step 2.2 represents Feature/Target Analysis. Feature and Target analysis provide insight into relationships observed in the data. It includes summary statistic and visual inspection of the data that is helpful in decision making with respect to the data partition and feature creation. MLWay has functionality to provide summary statistics for the target and any other feature along with an interactive graphical representation of the data for visual inspection and exploration.

Step 2.3 represents Data Partition and Segmentation. Data Partition and Segmentation are ultimately business decisions. Segmentation is needed where explanatory power of variables changes from one segment to another where one model developed on all segments do not work well on each segment individually and separate models for each segment would be the preferred approach to improve accuracy. For instance, risk metrics for Commercial and Industrial deals can be different from risk drivers for Investment Real Estate deals which would grant separate default prediction models from a business perspective. Data partition involves partitioning the data into training, validation and out of sample data, which is crucial to hyperparameter tuning, model selection, and performance analysis. Hyper parameters are specific to machine learning algorithms. Machine learning algorithms rely on model specific configuration inputs to search for the best model. These model specific configuration inputs are called hyper parameter. For example, Random Forest, a type of machine learning algorithm, has the following hyper parameters: Number of trees, Maximum Debt, Minimum number of data points in a node, Minimum number of data points in a leaf node, Bootstrap, or Maximum number of features. Other factors that play a role in segmentation and data portioning include the size of the data, business preference driven by business history (for example a specific business may want to omit certain time frames in the history due to different business landscape, unusual factors like Covid, or want to optimize model performance on a certain time frame). MLWay provides data size statistics and industry standards for minimum size requirements, customizable clustering analysis and variable importance analysis across selected segments to the user for an informed decision making consistent and true to their business domain knowledge.

Step 2.4 represents Feature Engineering Process. Feature engineering is the process of using domain knowledge to extract features from raw data that may have strong explanatory power for the target. These features have the potential to improve the performance of the end model manyfold. Feature Engineering process is one of the most crucial steps of any model development and has great implications on the model performance. Poor feature engineering can result in poor model performance or lost opportunity. Strong feature engineering results in more robust models in every aspect such as better stability and accuracy. Feature Engineering is a business decision informed by Business intuition and can be improved through statistical analysis and exploration where innovation and creativity play an important role. MLWay has an innovative and creative approaches to guide user to conduct robust feature engineering that includes the following processes, some of which are common to embodiment 1:

Feature Creation and Transformations: the user can use select all or some of the predefined transformation techniques in the software (over 20 transformation techniques) and/or define their own customized transformations to create new, potentially strong features to be considered in model development;

Feature Encoding: converting categorical data is an unavoidable activity in modeling. It not only elevates the model quality but also helps in better feature engineering. Better encoding leads to a better model and most of the algorithms cannot handle the categorical variables unless they are converted into numerical values. MLWay offers multiple encoding techniques such as ordinal encoding, One Hot Encoding and Label encoding. Ordinal encoding technique is used for ordinal variables where retaining the order is important. In label encoding, each label is converted into a numeric value via multiple statistical techniques. In One Hot Encoding, each categorical value is represented by a binary flag;

Feature Imputation: MLWay offers standard and novel techniques to conduct missing imputation: mean, median, most frequent, KNN, performance based, iterative imputation. Iterative imputation is one of the novel approaches and refers to a process where each feature is modeled as a function of the other features, e.g., a regression problem where missing values are predicted. Each feature is imputed sequentially, one after the other, allowing prior imputed values to be used as part of a model in predicting subsequent features. This process is repeated multiple times, allowing ever improved estimates of missing values to be imputed;

Feature Filtering: Feature filtering is relatively a new technique and leverages variance and information value to filter/create new features; and

Feature Selection/Reduction: Feature selection defines the selection of strongest variables in terms of their explanatory power against the target. Adequate Feature selection has great implications on model performance and computational burden. It is required to avoid the curse of dimensionality which can result in overfitting, instability, higher variance and/or unreasonable computational times. In MLWay, user can eliminate variables deemed to be unintuitive based on their domain knowledge regardless of the feature's explanatory power. MLWay offers various innovative statistical approaches to feature selection such as Recursive Feature Elimination, Model Ranked, Variance Threshold, Missing/low frequency Threshold, F Test, Ch2 Test, Lasso, Ridge, Backward, Forward and Stepwise sequential selections, Information Value, Variable Clustering where usage of these techniques depend on the candidate machine learning algorithm selected and the target type.

Step 2.5 represents Model Design: Algorithm/s selection. MLWay offers user to select preferred modeling technique/s to be used in model development and provide guidance in this decision making in the form of model technique descriptions, weaknesses, limitations and strengths. MLWay also auto select all applicable modeling techniques to be considered for the decision making. User also can select multiple techniques; can select a standalone model based on customizable ranking criteria or apply stacking where final model is based on the collective predictions of top models; each selected for instance from a different modeling technique or based on performance.

Step 2.6 represents Hyperparameter Tuning and Candidate Models. machine learning algorithms tend to come with many hyperparameters that can be optimized to increase accuracy. Hyperparameter optimization can be computationally intensive and costly. MLWay offers multiple ways to do hyperparameter optimization: Grid, Soft Grid, Randomized and Bayesian search. MLWay relies on cross validation to assess model performance in the hyperparameter optimization which can be customizable by the user.

Step 2.7 represents Model Ranking, Evaluation and Selection. Model Selection is a business decision ultimately and driven by the busines purpose. No Model is perfect and every model has weaknesses. Some model projects look for best performance through-out the whole available history, some look for best performance in most recent times, some look for best performance in out of sample (unknow data), some look for most stable models, some look for best performance in a specific segment, some look for less bias regardless of the uncertainty, some want to trade for less uncertainty by sacrificing on bias, some look for the soundest model based on statistical diagnostics. To this extent, best model definition is subject to business preference and purpose. MLWay offers many different customizable features to do model ranking and selection based on model stability, sensitivity, customizable performance evaluation that includes error distributions, bias and uncertainty calculations, and statistical diagnostics. The purpose of this functionality in the software is to improve the understanding of the model behavior, optimize against business purpose and help with the model risk and governance process. In this step, software produces a comprehensive report that includes all statistical diagnostics, performance evaluations, sensitivity, ranking based on user defined criteria. The user is able to change these ranking criteria and observe each candidate model's characteristics and behavior to make an informed decision to select the best model.

Step 2.8 represents Best Model step, analogous to step 7 of the first embodiment. Once best model is selected in Step 2.7, software produces all relevant detailed information on the best model; statistical diagnostics, sensitivity, back-test and performance analysis. Software provides additional functionality to do further in-depth output and sensitivity analysis. The user can select different performance windows in Input 2.8a for performance evaluation, apply customized sensitivity analysis, evaluate performance for different time frames and input scenarios in this module. Best model review outlined here is to understand model behavior, sensitivity to improve model explain-ability and transparency to better understand model behavior and risk and to help with model governance. MLWay software saves all relative analysis, data, output in a dedicated folder properly structured to be used in the model documentation. Robust and complete documentation of the whole development cycle is imperative for model risk management and regulatory purposes. MLWay also exports the execution code to be used in implementation. The implementation is used to achieve forecasting of a particular business output. For MLWay, example can provide predicting propensity (likelihood of a customer to apply for a product), fraud detection, and Probability of Default prediction to name a few.

Finally, Step 2.9 represents Model Comparison. MLWay enables the user to compare the best model to any other candidate model identified in the hyper parameter tuning. It is common in modeling to compare different models to enhance the output analysis of the best model and to assign a challenger model. User is able to assign a challenger in this step, in addition to best model.

The STSA Software is designed to guide the user in each and every step of the robust model development cycle. The core engine of the software is written in Python and provides the output to the user through an Application Programming Interface (API) stored in a cloud server. The user interface of the software interacts with the API that executes all analysis and provide the output back to the user in the form of a table and various graphics.

The STSA software can be used by any entity; organization, individual, or enterprise with need to develop time series models to predict their interest of target or targets consistent with their strategy and risk assumptions. The capability is best provided as a cloud service but can be delivered by other dedicated and non-dedicated infrastructures. It requires the user to provide the modeling data and configure the set up in each step based on their modeling purpose and associated business acumen. The STSA software is designed to produce relative output to help with model risk governance, wherein standardized documentation is produced in line with governance expectations and the execution code.

The MLWay software is designed to guide the user in each and every step of the robust Machine Learning Model development cycle. The core engine of the software is written in Python and provides the output to the user through an Application Programming Interface (API) stored in a cloud server, application server, or on a user device. User interface of the software interacts with the API that executes all analysis and provide the output back to the user in the form of a table and various graphics.

The MLWay software can be used by any entity, organization, individual, or enterprise with need to develop Machine Learning Models to predict their interest of target or targets consistent with their strategy and risk assumptions. The capability is best provided as a cloud service but can be delivered by other dedicated or non-dedicated infrastructures. It requires the user to provide the modeling data and configure the set up in each step based on their modeling purpose and associated business acumen. MLWay is designed to produce relative output to help with model risk governance.

The API provides data that goes into the table or the graph in a format a user interface (UI) can process (such as JSON format). The UI presents the information in a table or graph for the user. There is no input required from the user once the output is produced. Note that each step in the tool produces graphs or tables for the user. Once the best model is developed, a user may assign the project to complete and get the model execution code and the documentation (which are also functionalities for the tool). Documentation includes all graphs and tables produced; configurations selected during model development steps. The technology of machine learning and model training is improved because graphs and tables helps user to make inform decisions during the development and/or understand the impact of decisions. The invention further improves the technology of machine learning and model training by providing clear specific information on data, inputs and model to help with explainability, interpretability and transparency, during the process.

The user interface of the software may be provided in the form of an application on a user device such as a mobile phone, mobile device, tablet, smart watch, computer, server, etc. The application receives use input data, such as configuration information, target selection of user identified features, manual feature selection, and/or manual elimination of unwanted features from the user and may store the input locally in a memory of the user device. The user may input the user input data in any form convenient to the user such as selection from presented options, from prepopulated fields or drop-down menus, from manual entry of specific values, from uploading a data file containing the desired user input, etc. The user device may provide the user input data to an API that is locally installed on the user device or may provide the user input data to an API which resides on a cloud server, application server, or other user device. The user device may use a network communication data link such as WIFI, Ethernet, mesh network, cellular, mobile, or telecommunications data (3G, 4G, 5G, LTE), etc., to transfer the user input data to the API over the network. Or the user device may use a direct communication link such as a wireless digital transmitter and/or receiver, IR transmitter and/or receiver, or wired communication link (USB, Category 5 cable, coaxial cable, etc.) to transfer the user input data to the API.

The documentation generated by the invention documentation is in line with regulatory expectations, including scope (model purpose), data verification, model technique information, model assumption testing, model performance analysis, and sensitivity. The software fills in various sections with empirical information needed and the user can expand on it if necessary.

The documentation generated by the invention may produce a data file which is stored on a cloud server, application server, or user device for example in a memory of the cloud server, application server, or user device. The generated documentation data file may be transmitted over a network or direct communication link from a cloud server to another cloud server, from a cloud server to a user device, from an application server to another application server, from an application server to a user device, or from one user device to another user device. The generated documentation may be displayed on a display of a user device using the UI in a user readable format or by an image generated from the documentation may be projected onto a surface. The generated documentation may be formatted into a form such as an eBook, portable document format, image file, etc. The generated documentation may be printed using a digital printing device into a physical format such as printing on paper, card stock, etc.

Implementation code is generated by the invention in the MLWay or STSA methods. The implementation code may be a data file which is stored on a cloud server, application server, or user device for example in a memory of the cloud server, application server, or user device. The implementation code may be loaded in an executable format on the cloud server, application server, or user device for example in a memory of the cloud server, application server, or user device so that the cloud server, application server, or user device is configured to use the implementation code and trained model produced by the MLWay and/or STSA methods to make predictions or forecasts based on additional data being supplied to the model. The forecasts or predictions may be displayed on a display of a user device using the UI in a user readable format or by an image generated from the documentation may be projected onto a surface. The forecasts or predictions may be formatted into a form such as an eBook, portable document format, image file, etc. The forecasts or predictions may be printed using a digital printing device into a physical format such as printing on paper, card stock, etc.

In a preferred embodiment, the machine learning method of the invention may be used to predict the delinquency ratio and loss rate for a portfolio of receivable accounts based on macro factors and input data of features, hyperparameters, configurations, and selections from the user such as: Number of times target variables are differenced, Maximum Number of Lags, P Value Threshold, Maximum Number of Model Inputs, Seasonality(Yes or No), and Model Type (e.g. ARIMA, SARIMA, VAR, ECM, LOS and VECM; Gradient Boosting, Stochastic Boosting, AdaBoost, XGBoost, LightBoost, KNN, K-Means, PCA, Logistic Regression, Decision Tree, Random Forest, Quadratic Linear Discrimination, Neural Networks, and Deep Learning).

Example: Develop a model that predicts 30+delinquency ratio and loss rate based on macro factors. In this example configuration can be:

Number of times target variables are differenced: 2

Maximum Number of Lags: 4

P Value Threshold=0.1

Maximum Number of Model Inputs=4

Seasonality(Yes or No)=Yes

Model Type=VECM

Using the MLWay or STSA method, models are trained using a set of training data, then ranked, and a best model is selected. The best model may be used to generate documentation materials specific to the task of predicting the 30+delinquency ratio and loss rate. The method may further generate implementation code based on the determined best portfolio prediction model. The trained best model and/or implementation code may be used to determine the 30+delinquency ratio of and loss rate on a specific portfolio of receivable accounts that a user wants to analyze. The forecasted delinquency ratio and loss rate of the portfolio may be used to determine steps to be taken to mitigate delinquency or loss. For example, the portfolio may be sold to a buyer, individual accounts in the portfolio may be sold to a buyer, additional accounts may be bought and added to the portfolio to create an augmented portfolio with a predicted lower delinquency ratio or loss rate, holders of accounts within the portfolio may be sent messages regarding their account status, and additional products or services may be offered to account holders predicted to be delinquent or result in a loss, to name a few.

In another preferred embodiment STSA and MLWay may be used to generate a model to determine when to grow certain crops (corn, soybeans, rice, sorghum, wheat, cotton, tobacco, etc.) in a geographic region or region based on macrofactors and input data of features, hyperparameters, configurations, and selections from the user such as Number of times target variables are differenced, Maximum Number of Lags, P Value Threshold, Maximum Number of Model Inputs, Seasonality(Yes or No), and Model Type (e.g. ARIMA, SARIMA, VAR, ECM, LOS and VECM; Gradient Boosting, Stochastic Boosting, AdaBoost, XGBoost, LightBoost, KNN, K-Means, PCA, Logistic Regression, Decision Tree, Random Forest, Quadratic Linear Discrimination, Neural Networks, and Deep Learning).

Macrofactors, variables, factors, and features include climate data, weather data, temperature data, precipitation data for a specific location geographic location. Additional macrofactors, variables, factors, and features include soil condition (pH, alkalinity, humic substance content, NPK values, drainage and water retention qualities, etc.).

Using the MLWay or STSA method, models are trained using a set of training data, then ranked, and a best model is selected. The best model may be used to generate documentation materials specific to the task of determining when to plant certain crops, when the crops should be watered, when soil amendments (e.g. as fertilizer, herbicide) should be provided. The method may further generate implementation code based on the determined best agricultural model. The trained best model and/or implementation code may be used to take specific actions based on the determined best model. Specific actions taken based on the output of selected best model may include amending the soil with certain amendments and at certain times, planting a species of crop or cultivar thereof at a determined time, watering the crops on a determined water schedule, and harvesting the crops at a determined time. The MLWay or STSA method improve the technology in agriculture by enhancing crop yield based on the modeled weather profile and/or by reducing the need for costly inputs to the farmed area such as fertilizer, herbicide, and water are used.

In another preferred embodiment STSA and MLWay may be used to generate a model to automatically order retail products to replenish inventory of a merchant based on macrofactors and input data of features, hyperparameters, configurations, and selections from the user such as Number of times target variables are differenced, Maximum Number of Lags, P Value Threshold, Maximum Number of Model Inputs, Seasonality(Yes or No), and Model Type (e.g. ARIMA, SARIMA, VAR, ECM, LOS and VECM; Gradient Boosting, Stochastic Boosting, AdaBoost, XGBoost, LightBoost, KNN, K-Means, PCA, Logistic Regression, Decision Tree, Random Forest, Quadratic Linear Discrimination, Neural Networks, and Deep Learning).

Using the MLWay or STSA method, models are trained using a set of training data, then ranked, and a best model for predicting inventory is selected. The best model may be used to generate documentation materials specific to the task of determining when order additional inventory. The method may further generate implementation code based on the determined best inventory prediction model. The trained best model and/or implementation code may be used to take specific actions based on the determined best inventory prediction model. Specific actions taken based on the output of selected best model may include automatically placing orders with vendors and suppliers for products or automatically generating purchase orders for products which are then reviewed by a user before being placed with a vendor or supplier. Predicting the quantity of goods likely to arrive damaged or non-conforming; tracking the delivery route and estimating delivery times and windows; and scheduling of warehouse or stock room workers, robots, and/or inventory stockers.

The MLWay and/or STSA methods additionally may be used to generate best models for predicting sales, income, and profit for a company; making stock price forecasts; making forecasts of population growth, death rates, and/or birth rates; forecasting Covid-19 cases, hospitalizations, and/or deaths; predicting a patient's likelihood of surviving cancer based on health condition, vital statistics, and cancer type and stage; predicting an individual's likelihood to buy a product or like a product for marketing purposes.

Described above are merely embodiments of the present invention, and are not intended to limit the present invention. Various changes and modifications can be made to the present invention by those skilled in the art. Any modifications, equivalent replacements, improvements, etc. made within the spirit and scope of the present invention should be included within the protection scope of the claims of the present invention.

What is claimed:

1. A process for building, developing, and enhancing a model for use in forecasting, the process comprising the following steps:
a first user input step, wherein a user to input data using a user interface on a user device and providing the user input data to an application program interface (API);
the API performs:
an auto data validation step comprising using the user input data to apply the following to the raw training data: elimination of duplicate data, either manually or standardized, selection of missing imputation functions, identification of low frequency values in categorical variables and proposing to eliminate or keep the categorical variables, and capping values or input standardization to form outlier identification;
a feature creation step comprising using domain knowledge to extract features from raw training data;
a feature encoding step comprising using the created features and raw training data to train different candidate models;
a model selection step wherein the user is prompted to select a best model from the number of trained candidate models based on user defined model rankings;
a best model review step comprising producing detailed information on the best model through statistical diagnostics, sensitivity, back-test and performance analysis; and
generating implementation code for the best model;
processing a set of data to be analyzed using the best model, forecasting an outcome based on processing the set of data to be analyzed with the best model, and providing the forecast to a user by a user interface on a user device.

2. The process for building, developing, and enhancing a model for use in forecasting of claim 1, wherein:
the feature creation step comprising using domain knowledge to extract features from raw training data comprises at least one of the following: log, polynomial, interaction functions such as division of two inputs, multiplication of two inputs, momentum, drift, and variance functions;
a feature imputation step is performed after the feature creation step, the feature imputation step comprises modeling each feature as a function of each other feature, imputing each feature sequentially, and allowing each feature to be used to predict subsequent features; wherein the feature imputation process step is repeated at least once, and wherein imputing is performed using one of: KNN, performance-based, iterative imputation, mean, median, and mode; and
the feature encoding step further comprising using a categorical data encoding technique when the categorical variables are ordinal, producing labels through label encoding, ordinal coding or one hot encoding, and converting the labels into numeric values via multiple statistical techniques.

3. The process for building, developing, and enhancing a model for use in forecasting of claim 2, wherein the different candidate models are selected from at least one of the following time series models: ARIMA, SARIMA, VAR, ECM, and VECM.

4. The process for building, developing, and enhancing a model for use in forecasting of claim 3, further comprising a best model validation step producing a comprehensive report of the statistical diagnostics tests, performance evaluations, sensitivity analysis, and model ranking based on the configuration selected by the user.

5. The process for building, developing, and enhancing a model for use in forecasting of claim 3, further comprising:
a model comparison step comprising comparing the best model to another model in the number of candidate models with an option to determine a new best model; and
a documentation materials step comprising saving the comprehensive report as a file.

6. The process for building, developing, and enhancing a model for use in forecasting of claim 2, wherein the different candidate models are selected from at least one of the following machine learning models: Gradient Boosting, Stochastic Boosting, AdaBoost, XGBoost, LightBoost, KNN, K-Means, PCA, Logistic Regression, Decision Tree, Random Forest, Quadratic Linear Discrimination, Neural Networks, and Deep Learning.

7. The process for building, developing, and enhancing a model for use in forecasting of claim 6, further comprising:
a feature and target analysis step comprising providing summary statistic and visual inspection of the data that is helpful in decision making with respect to a data partition and a feature creation;
a data partition and segmentation step comprising partitioning the data into training data, validation data, and out-of-sample data for use in hyperparameter tuning, model selection, and performance analysis, and providing data size statistics and industry standards for minimum size requirements, customizable clustering analysis and variable importance analysis across partitions;
a feature filtering step comprising leveraging variance and information values to filter or create new features;
a model design step comprising selecting, automatically or manually by user input, all applicable models of the set of models, a standalone model of the set of models based on customizable ranking criteria, or applying stacking wherein a final model is based on a collective prediction of at least one model of the set of models;
a hyperparameter tuning step applied to each of the number of candidate models comprising applying at least one of the following techniques: Grid, Soft Grid, Randomized and Bayesian search; and
a model ranking step comprising comparing the best model to another model in the set of models based on model stability, sensitivity, and/or customizable performance evaluation that includes error distributions, bias and uncertainty calculations, and statistical diagnostics.

8. The process for building, developing, and enhancing a model for use in forecasting of claim 6, wherein the feature creation step further comprising defining a selection of strongest variables in terms of explanatory power against the target selection input, and applying at least one selected from the following: Recursive Feature Elimination, Model Ranked, Variance Threshold, Missing/low frequency Threshold, F Test, Ch2 Test, Lasso, Ridge, Backward, Forward and Stepwise sequential selections, Information Value, and Variable Clustering.

9. The process for building, developing, and enhancing a model for use in forecasting of claim 2, wherein the feature creation process step further comprises: wherein the user selects at least one of the features to extract potential inputs, and/or wherein the user eliminates variables deemed to be unintuitive based on domain knowledge.

10. The process for building, developing, and enhancing a model for use in forecasting of claim 2, further comprising a model comparison step comprising comparing the best model to another model in the number of candidate models with an option to determine a new best model.
